(19) United States
(12) Patent Application Publication
(10) Pub. No.: US 2009/0006676 A1
(43) Pub. Date: Jan. 1, 2009

(54) Method for Scheduling a Device Notification Time Slot for a Wireless USB System

(75) Inventors: PRAVEEN Sampat, Chandler, AZ (US); RAKESH Avichal Ughreja, Bangalore (IN)

Correspondence Address: GROSSMAN, TUCKER, PERREAULT & PFLEGER, PLLC;C/O Intellevate, LLC, P. O. BOX 52050, MINNEAPOLIS, MN, 55402, US

(73) Assignee: INTEL CORPORATION, Santa Clara, CA (US)

(21) Appl. No.: 11/771,562

(22) Filed: Jun. 29, 2007

(51) Int. Cl. G06F 13/38

(52) U.S. Cl. 710/62

(57) ABSTRACT

Disclosed is a method for scheduling a Device Notification Time Slot (DNTS) for transferring a data between a wireless Universal Synchronous Bus (USB) device and a wireless USB host. The method comprises determining whether the wireless USB device endpoint is in a flow control state; performing one of scheduling the DNTS in each of a plurality of Micro-scheduled Management Commands (MMCs) and scheduling the DNTS after a fixed time interval in a MMC of the plurality of MMCs upon determining whether the wireless USB device endpoint is in the flow control state; and transferring the data between the wireless USB device and the wireless USB host when the wireless USB device is ready for transferring the data and the wireless USB device has received the DNTS in the MMC of the plurality of MMCs.

### FIELD

The present disclosure relates to scheduling of asynchronous device notifications and, more particularly, to a method for scheduling Device Notification Time Slot (DNTS) between a wireless Universal Synchronous Bus (USB) device and a wireless USB host.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 is a block diagram illustrating a wireless USB system, according to an exemplary embodiment of the present disclosure;

FIG. 2 is a diagram illustrating a flow of messages in a traditional method for transferring a data between the wireless USB device and the wireless USB host;

FIG. 3 is a diagram illustrating a flow of messages for transferring the data between the wireless USB device and the wireless USB host, according to an exemplary embodiment of the present disclosure;

FIG. 4 is a flow diagram of a method for scheduling a Device Notification Time Slot (DNTS) for transferring the data between the wireless USB device and the wireless USB host, according to an exemplary embodiment of the present disclosure; and

FIG. 5 is a flow diagram for scheduling the DNTS for transferring the data between the wireless USB device and the wireless USB host when the wireless USB device is in a flow control state, according to an exemplary embodiment of the present disclosure.

Like reference numerals refer to like parts throughout the description of several views of the drawings.

### DETAILED DESCRIPTION

For a thorough understanding of the present disclosure, reference is to be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms “a” and “an” herein do not denote a limitation of quantity, but rather denote the presence of at least one of the referenced items.

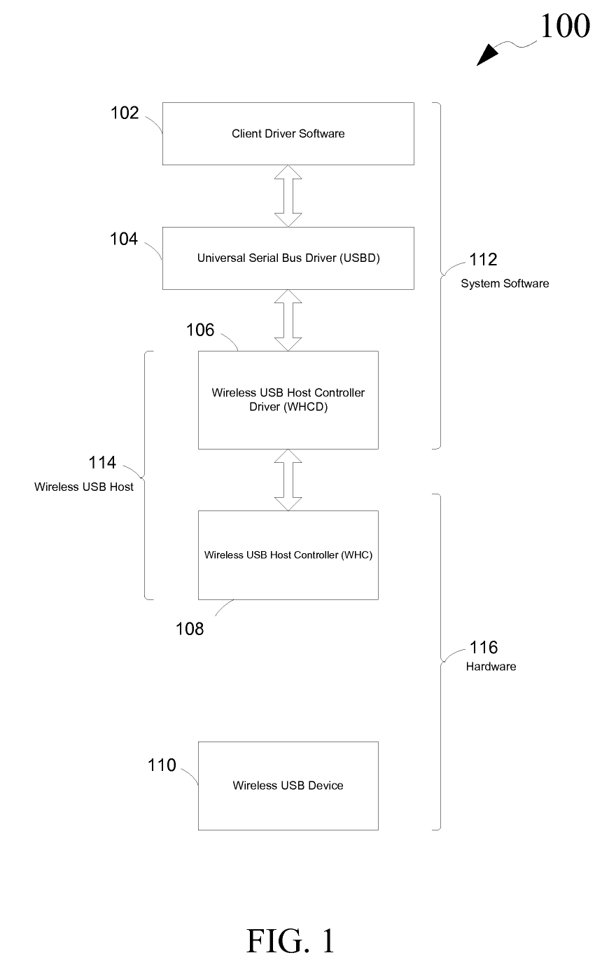

FIG. 1 is a block diagram illustrating a wireless USB system 100. The wireless USB system 100 (hereinafter referred to as system 100) includes a system software 112, a wireless USB host 114 and a hardware 116. The system software 112 includes a client driver software 102, a USB driver 104 and a Wireless USB Host Controller Driver (WHCD) 106. The client driver software 102 provides a software support to a wireless USB device 110, for example, a client driver software of a wireless USB keyboard. The client driver software enables the wireless USB keyboard to function properly and provides the software support to the wireless USB keyboard.

The USB driver 104 provides a support to the wireless USB device 110 so that any computer program may communicate with the wireless USB device 110. The USB driver 104 communicates with a computer bus and subsystem or subsystems with which the wireless USB device 110 is connected. When a computer program invokes a routine in the USB driver 104, the USB driver 104 issues commands to the wireless USB device 110, and when the wireless USB device 110 transfers a data, the USB driver 104 invokes the routine in the computer program. The WHCD 106 provides the support to a wireless USB host controller 108.

The wireless USB host 114 includes the WHCD 106 and the Wireless USB Host Controller (WHC) 108. The WHC 108 controls the wireless USB device 110. The WHC 108 can be based on a Peripheral Component Interconnect (PCI) standard or a USB standard. The wireless USB host 114 defines wireless channels over the air for the wireless USB device 110, the wireless channels are described by a special wireless packet called Micro-scheduled Management Commands (MMCs). The wireless USB host 114 uses the MMCs to instruct the wireless USB device 110 to transfer the data between the wireless USB host 114 and the wireless USB device 110.

The hardware 116 of the system 100 includes the WHC 108 and the wireless USB device 110. The examples of the wireless USB device 110 may include but not limited to a mouse, a keyboard, a flash drive, a camera, a scanner, a printer, a joystick and a personal digital assistant.

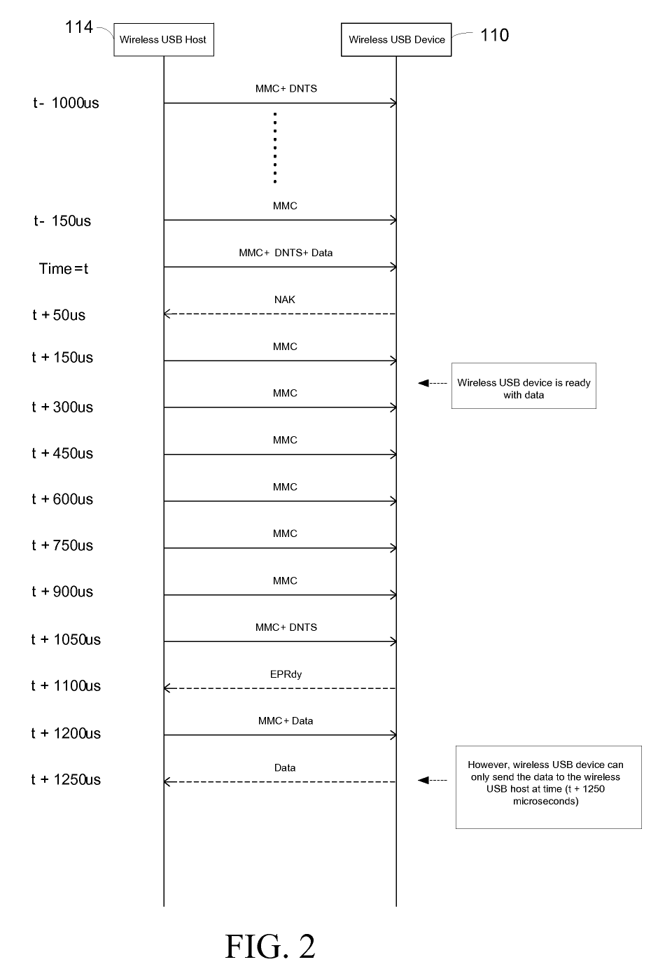

FIG. 2 is a diagram illustrating a flow of messages in a traditional method for transferring of the data between the wireless USB device 110 and the wireless USB host 114. For asynchronous wireless USB device 110 initiated notifications, the wireless USB host 114 sends a specific channel time for the wireless USB device 110 to send the notification. The specific channel time is called Device Notification Time Slot (DNTS). The WHCD 106 is responsible for configuring the WHC 108 to schedule the DNTS. Further, a number of factors are considered while making a decision regarding how often a DNTS should be scheduled and how many DNTSs should be scheduled. For example, in order to make efficient use of a bandwidth of a wireless USB channel, the DNTS is scheduled after a fixed interval of time. Also, scheduling too many DNTS, for example, in each of the MMCs will result in a waste of the bandwidth of the wireless USB channel.

Alternatively, not scheduling enough DNTSs in MMCs may starve wireless a USB device 110 waiting to transfer the data to the wireless USB host 114. The WHCD 106 configures the WHC 108 to schedule a DNTS in each of the MMCs or schedule a DNTS after a periodic time interval, for example, a periodic interval of 1 milli-second. Scheduling the DNTS in each MMC in this manner results in a waste of the bandwidth of the wireless USB channel.

In the traditional method, the WHCD 106 will configure the WHC 108 to schedule a DNTS after the periodic time interval. At time (t), the wireless USB host 114 schedules a request for transferring of the data to the wireless USB device 110. At time (t+50 us) (microseconds), the wireless USB device 110 replies with a Negative acknowledgement (NAK). The NAK indicates that the wireless USB device 110 is not ready to transfer the data. The device is not ready to transfer the data when a number of buffers required to transfer the data in the wireless USB device 110 is less than a predetermined value.

The predetermined value is the least number of buffers required for receiving and sending the data by the wireless USB device 110. The wireless USB host 114 waits for an Endpoint Ready (EPRdy) notification from the wireless USB device 110 which is received at time (t+1100 us) before scheduling the request for transferring of the data. The wireless USB device 110 then transfers the data at time (t+1200 us). However, the wireless USB device 110 was ready to transfer the data at time (t+300 us). But the wireless USB device 110 is unable to transfer the data at time (t+300 us) because the DNTS was sent by the wireless USB host 114 at time (t+1050 us). The wireless USB device 110 thus is kept waiting from the time (t+300 us) until the time (t+1250 us) to transfer the data, thereby making the wireless USB system 100 inefficient.

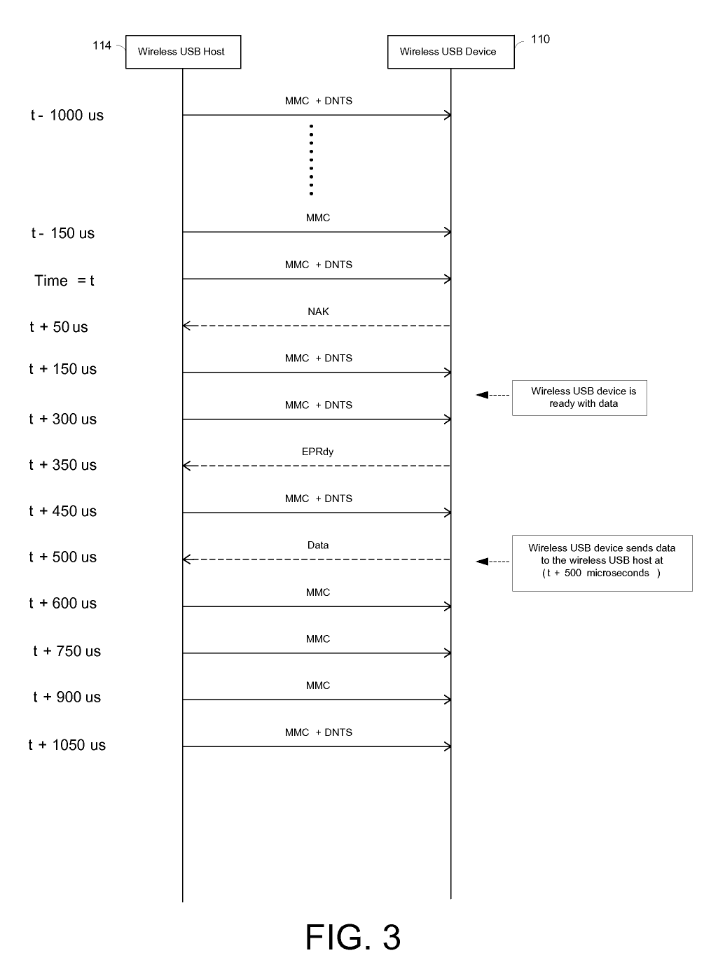

FIG. 3 is a diagram illustrating a flow of messages for transferring the data between the wireless USB device 110 and the wireless USB host 114 according to an exemplary embodiment of the present disclosure. The disclosure describes an algorithm that efficiently schedules the DNTS for a type of wireless USB device 110 notifications EPReady. Whenever the wireless USB device 110 does not have enough number of buffers to receive the data from the wireless USB host 114 or does not have enough number of buffers to transfer the data to the wireless USB host 114, then the wireless USB sends a NAK to the wireless USB host 114.

Once the WHC 116 receives the NAK response from the wireless USB device 110, then the WHC 108 places an endpoint into a flow control state and no longer schedules transfer of the data to the endpoint. The WHC 108 will wait for the EPReady notification from the wireless USB device 110 before scheduling transfer of the data to the wireless USB host 114. In the flow control state, the Wireless USB host 114 provides the Wireless USB device 110 a plurality of opportunities to send the EPReady notification. However, if the WHCD 106 configures the WHC 108 to schedule the DNTS after the periodic time interval, for example, 1 milli-second, then it will delay the time when the wireless USB device 110 sends the EPReady notification to the wireless USB host 110. This results in degradation of a throughput and makes the wireless USB system 100 inefficient.

In the present disclosure, the WHC 108 schedules the DNTS in each of the MMCs when the wireless USB device 110 endpoint is in the flow control state. The WHC 108 may also schedule the DNTS after a fixed interval of time when the wireless USB device 110 endpoint is not in the flow control state. The disclosure provides a fair trade-off between efficient utilization of the bandwidth of the Wireless USB device 110 and data throughput between the wireless USB host 114 and the wireless USB device 110. The bandwidth of the Wireless USB device 110 is not wasted. Furthermore, the wireless USB device 110 may immediately notify the wireless USB host 114 when the wireless USB device 110 is ready to transfer the data.

According to an embodiment of the present disclosure, the WHCD 106 configures the WHC 108 to schedule DNTS in each of the MMCs. At time (t), the wireless USB host 114 schedules a request for transfer of the data to the wireless USB device 110. At time, (t+50 us), the wireless USB device 110 replies with the NAK. The NAK indicates that the wireless USB device 110 is not ready to transfer the data. The wireless USB host 114 schedules the DNTS in each of the MMCs because the wireless USB device 110 is in the flow control state.

The wireless USB device 110 is ready to transfer the data at time (t+300 us), because the wireless USB host 114 has scheduled the DNTS in each of the MMCs. The wireless USB host 114 responds with the EPRdy at time (t+350 us). The wireless USB host 114 schedules the transfer of data in the next MMC and the wireless USB device 110 transfers the data at time (t+500 us). Thereby a time of (750 us) is saved, in contrast to the traditional method described earlier in conjunction with FIG. 2.

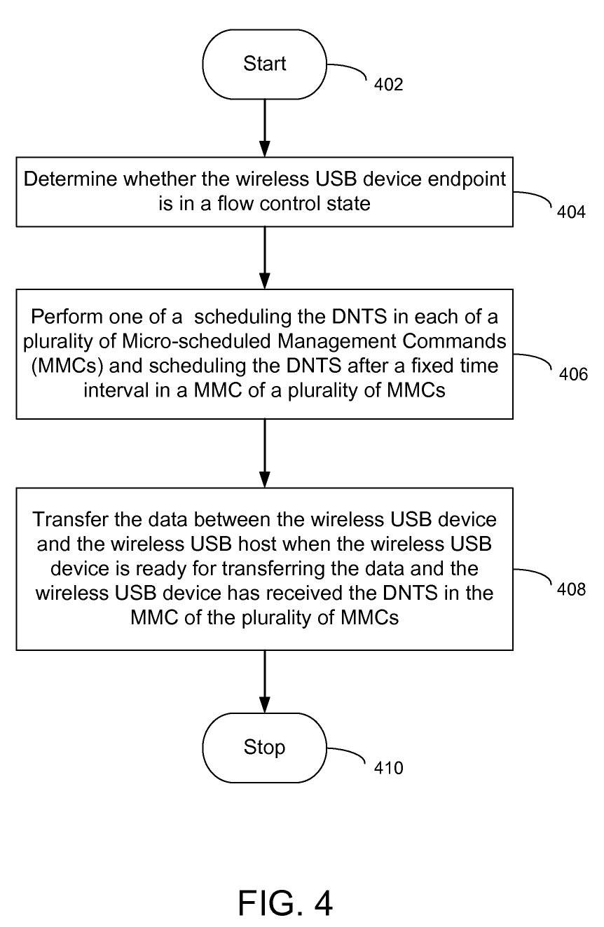

FIG. 4 is a flow diagram of a method for scheduling the DNTS for transferring the data between the wireless USB device 110 and the wireless USB host 114. The method initiates at 402. At 404, it is determined whether the wireless USB device 110 endpoint is in the flow control state. The flow control state occurs when the number of buffers in the wireless USB device 110 needed for transferring the data between the wireless USB host 114 and the wireless USB device 110 is less than the predetermined value. At 406, the WHCD 106 configures the WHC 108 to perform one of scheduling the DNTS in each of a plurality of MMCs as described in conjunction with FIG. 3 and scheduling the DNTS after the fixed time interval in a MMC of the plurality of MMCs as described in conjunction with FIG. 2.

The decision to schedule the DNTS in each of the plurality of MMCs and to schedule the DNTS after the fixed time interval is based upon the determination of whether the wireless USB device 110 endpoint is in the flow control state or not. If the wireless USB device 110 is in the flow control state, then the DNTS is scheduled in each of the plurality of MMCs, otherwise the DNTS is scheduled after the fixed time interval in the MMC of the plurality of MMCs. At 408, the data is transferred between the wireless USB device 110 and the wireless USB host 114 when the wireless USB device 110 is ready for data transfer and the wireless USB device 110 has received the DNTS in the MMC of the plurality of MMCs.

The wireless USB device 110 is ready for data transfer when the number of buffers needed for transferring the data in the wireless USB device 110 is more than or equal to the predetermined value. The predetermined value is the least number of buffers required for receiving and sending the data by the wireless USB device 110. The wireless USB device 110 may receive or send the data only when the wireless USB device 110 has enough number of buffers to send or receive the data. Once the wireless USB device 110 is ready for data transfer and the wireless USB device 110 has received the DNTS in the MMC of the plurality of MMCs, then only the wireless USB device 110 can transfer the data between the wireless USB host 114 and the wireless USB device 110. The method terminates at 410.

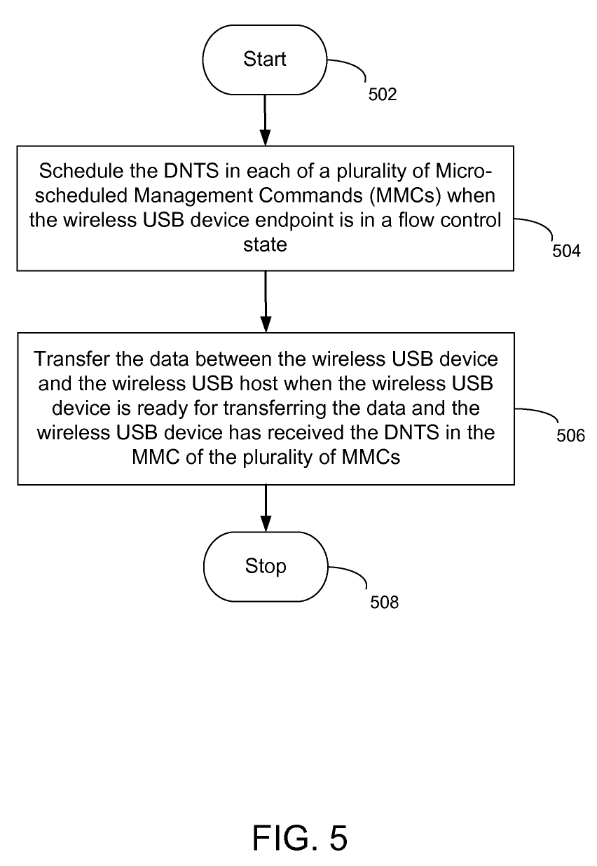

FIG. 5 is a flow diagram for scheduling the DNTS for transferring the data between the wireless USB device 110 and the wireless USB host 114 when the wireless USB device 110 is in the flow control state. The method initiates at 502. At 504, the DNTS is scheduled in each of a plurality of MMCs as described in conjunction with FIG. 3. At 506, the data is transferred between the wireless USB device 110 and the wireless USB host 114 when the wireless USB device 110 is ready for transferring the data and the wireless USB device 110 has received the DNTS in the MMC of the plurality of MMCs. The method terminates at 508.

The present disclosure provides a method whereby the Wireless USB host 114 has to make a decision between whether to make efficient use of the bandwidth of the Wireless USB channel or to sacrifice bandwidth efficiency to improve data throughput to the Wireless USB device 110. The implementation of the method described in this disclosure in the WHCD 106 allows the Wireless USB host 114 to dynamically (at run-time) make the decision on whether to prioritize data throughput or channel utilization efficiency, i.e. scheduling the DNTS in each of the MMCs or scheduling the DNTS after the fixed time interval in the MMC of the plurality of MMCs. Accordingly, the present disclosure prevents unnecessary wastage of the bandwidth of the wireless USB channel, without sacrificing at the same time the throughput to the Wireless USB device 110.

Based on measurements of a prototype implementation of this disclosure, the implementation of the method described above results in a 10% improvement in the efficiency of the wireless USB system 100.

As described above, the embodiments of the disclosure may be embodied in the form of computer-implemented processes and apparatuses for practicing those processes. Embodiments of the disclosure may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the disclosure. The present disclosure can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the disclosure. When implemented on a general-purpose microprocessor, the computer program code segments configure the microprocessor to create specific logic circuits.

The foregoing descriptions of specific embodiments of the present disclosure have been presented for the purposes of illustration and description. They are not intended to be exhaustive or to limit the disclosure to the precise forms disclosed, and obviously many modifications and variations are possible in light of the above teaching. The embodiments were chosen and described in order to best explain the principles of the disclosure and its practical application, to thereby enable others skilled in the art to best utilize the disclosure and various embodiments with various modifications as are suited to the particular use contemplated. It is understood that various omissions and substitutions of equivalents are contemplated as circumstance may suggest or render expedient, but such modifications are intended to cover the application or implementation without departing from the spirit or scope of the claims of the present disclosure.

What is claimed is:

1. A method for scheduling a Device Notification Time Slot (DNTS) for transferring data between a wireless Universal Synchronous Bus (USB) device and a wireless USB host, the method comprising:
determining whether the wireless USB device endpoint is in a flow control state;
performing one of:
scheduling the DNTS in each of a plurality of Micro-scheduled Management Commands (MMCs), or
scheduling the DNTS after a fixed time interval in a MMC of the plurality of MMCs upon determining whether the wireless USB device endpoint is in the flow control state,
wherein the plurality of MMCs are received by the wireless USB device from the wireless USB host; and
transferring the data between the wireless USB host and the wireless USB device when the wireless USB device is ready for data transfer and the wireless USB device has received the DNTS in the MMC of the plurality of MMCs.

2. The method of claim 1, wherein the DNTS is scheduled in each of the plurality of MMCs when the wireless USB device is in the flow control state.

3. The method of claim 1, wherein determining whether the wireless USB device endpoint is in the flow control state is done at a run time.

4. The method of claim 1, wherein a wireless USB host controller driver configures the wireless USB host to schedule the DNTS.

5. The method of claim 4, wherein the wireless USB host controller driver comprises a client driver software, a USB driver and a wireless USB host controller driver.

6. The method of claim 1, wherein the wireless USB device is one of a mouse, a keyboard, a flash drive, a camera, a scanner, a printer, a joystick and a personal digital assistant.

7. The method of claim 1, wherein the flow control state occurs when a number of buffers in the wireless USB device needed for transferring the data between the wireless USB host and the wireless USB device is less than a predetermined value.

8. A computer program product embodied on a computer readable medium for scheduling a Device Notification Time Slot (DNTS) for transferring a data between a wireless Universal Synchronous Bus (USB) device and a wireless USB host, the computer program product comprising a program module having instructions for:
determining whether the wireless USB device endpoint is in a flow control state, performing one of:
scheduling the DNTS in each of a plurality of Micro-scheduled Management Commands (MMCs), or
scheduling the DNTS after a fixed time interval in a MMC of the plurality of MMCs upon determining whether the wireless USB device endpoint is in the flow control state,
wherein the plurality of MMCs are received by the wireless USB device from the wireless USB host; and
transferring the data between the wireless USB host and the wireless USB device when the wireless USB device is ready for transferring the data and the wireless USB device has received the DNTS in the MMC of the plurality of MMCs.

9. The computer program product of claim 8, wherein the DNTS is scheduled in each of the plurality of MMCs when the wireless USB device is in the flow control state.

10. The computer program product of claim 8, wherein determining whether the wireless USB device endpoint is in the flow control state is done at a run time.

11. The computer program product of claim 8, wherein a wireless USB host controller driver configures the wireless USB host to schedule the DNTS.

12. The computer program product of claim 11, wherein the wireless USB host controller driver comprises a client driver software, a USB driver and a wireless USB host controller driver.

13. The computer program product of claim 8, wherein the wireless USB device is one of a mouse, a keyboard, a flash drive, a camera, a scanner, a printer, a joystick and a personal digital assistant.

14. The computer program product of claim 8, wherein the flow control state occurs when a number of buffers in the wireless USB device needed for transferring the data between the wireless USB host and the wireless USB device is less than a predetermined value.

15. A method for scheduling a Device Notification Time Slot (DNTS) for transferring a data between a wireless Universal Synchronous Bus (USB) device and a wireless USB host, the method comprising:
scheduling the DNTS in each of a plurality of Micro-scheduled Management Commands (MMCs) when the wireless USB device endpoint is in a flow control state,; and
transferring the data between the wireless USB host and the wireless USB device when the wireless USB device is ready for transferring the data and the wireless USB device has received the DNTS in a MMC of the plurality of MMCs.

16. The method of claim 15, wherein a wireless USB host controller driver configures the wireless USB host to schedule the DNTS.

17. The method of claim 15, wherein the wireless USB host controller driver comprises a client driver software, a USB driver and a wireless USB host controller driver.

18. The method of claim 15, wherein the wireless USB device is one of a mouse, a keyboard, a flash drive, a camera, a scanner, a printer, a joystick and a personal digital assistant.

19. The method of claim 15, wherein the flow control state occurs when a number of buffers in the wireless USB device needed for transferring the data between the wireless USB host and the wireless USB device is less than a predetermined value, and wherein the plurality of MMCs are received by the wireless USB device from the wireless USB host.
